(19) United States
(12) Patent Application Publication
(10) Pub. No.: US 2015/0073699 A1
(43) Pub. Date: Mar. 12, 2015

(54) SERVER AND METHOD FOR OUTPUTTING MAP IMAGE

(71) Applicant: DeNA Co., Ltd., Tokyo (JP)

(72) Inventor: Yosaku TOYAMA, Tokyo (JP)

(73) Assignee: DeNA Co., Ltd., Tokyo (JP)

(21) Appl. No.: 14/094,653

(22) Filed: Dec. 2, 2013

(30) Foreign Application Priority Data
Sep. 11, 2013 (JP) 2013-188725

(51) Int. Cl. G01C 21/00

(52) U.S. Cl. CPC G01C 21/00
USPC 701/431

(57) ABSTRACT

A server according to one embodiment displays on a map image a position corresponding to a user with consideration for user privacy. The server executes a program for outputting a map image including: a user specifying module configured to specify, based at least on a present position of one or more users, the one or more users for whom user elements are arranged on the map image; a determination module configured to determine a modification direction and a modification distance used to modify the present location corresponding to the one or more users thus specified; an arrangement module configured to arrange the user elements on the map image at a position corresponding to the present location modified according to the determined modification direction and the determined modification distance; and an output module configured to output to a terminal device the map image having the user elements arranged thereon.

### CROSS-REFERENCE TO RELATED APPLICATIONS

This application claims priority to Japanese Patent Application No. 2013-188725 (filed on Sep. 11, 2013), the entire contents of which are incorporated herein by reference.

### FIELD OF THE INVENTION

The present invention relates to a server and a method for outputting a map image, and more specifically, to a server for outputting to a terminal device communicably connected, a map image having user elements arranged thereon, each corresponding to one or more users, and to a method for outputting such a map image.

### BACKGROUND

There have been placed on the market, services of conventional art which uses a technique of acquiring user position information by use of GPS, information from base stations of cell phone, or the like, and then displaying the user position on a map image based on the acquired position information (for example, refer to Japanese Patent Laid-Open No. 2013-134072). For example, a navigation system is well known by which a route to the destination is displayed in a guiding manner while the present location of the user is displayed. In recent years, in an SNS service, a function is also provided by which a user displays his/her location on a map image to perform a posting operation related to that location.

However, when the map image displaying the user position in this manner is provided, since the user position information is privacy-related data, some users may feel uncomfortable, for example, with the fact that the exact present location is known by other users. Particularly, many users does not desire that the exact present location is known by other users when they are at a private spot such as home or the like. On the other hand, if the displaying of user position on a map image is perfectly stopped, it is impossible to provide various types of services using user position information.

An object of embodiments of the present invention is to display a position corresponding to a user on a map image with consideration for user privacy. Other object of the present invention will be clearly known by reference to the whole description of this specification.

### SUMMARY

A server according to one embodiment of the present invention is one which outputs to a terminal device communicably connected, a map image having one or more user elements arranged thereon, each corresponding to a respective user. The server includes one or more processors capable of executing a predetermined program. The predetermined program includes: a determination module configured to determine, according to a request to output the map image, a modification direction and a modification distance used to modify a geographical position corresponding to a user for whom the user element is arranged on the map image; an arrangement module configured to arrange the user elements on the map image at positions corresponding to the geographical positions modified according to the determined modification direction and the determined modification distance; and an output module configured to output to the terminal device the map image having the user elements arranged thereon. Here, the “user elements” include various types of elements corresponding to a user which can be arranged on the map image; for example, an image such as an icon and a text may be included. The “geographical position corresponding to a user” includes various geographical positions which may correspond to a user; for example, the present location, the area of residence and the place of business may be included.

A method according to one embodiment of the present invention is for outputting a map image having one or more user elements arranged thereon, each corresponding to a respective user. This method includes, determining a modification direction and a modification distance used to modify a geographical position corresponding to a user for whom the user element is arranged on the map image, according to a request to output the map image; arranging the user elements on the map image at a position corresponding to the geographical position modified according to the determined modification direction and the determined modification distance; and outputting the map image having the user elements arranged thereon.

Various embodiments of the present invention allows displaying of a position corresponding to a user on a map image with consideration for user privacy.

### BRIEF DESCRIPTION OF THE DRAWINGS

FIG. 1 is a block diagram schematically illustrating a hardware configuration of a system 1 including a server 10 according to one embodiment of the present invention;

FIG. 2 is a block diagram schematically illustrating a module configuration of a map image outputting program 50 according to the one embodiment

FIG. 3 is a flowchart illustrating an example of map image outputting processing according to the one embodiment

FIG. 4 is a view for explaining a method for modifying a user geographical position according to the one embodiment

FIG. 5 is a view showing an example of map image 60 according to the one embodiment

FIG. 6 is a view for explaining the relationship between the map image 60 and the present location of users according to the one embodiment

FIG. 7 is a view showing an example of map image 60 according to the one embodiment and

FIG. 8 is a view for explaining the relationship between the map image 60 and the present location of users according to another embodiment.

### DESCRIPTION OF EXAMPLE EMBODIMENTS

FIG. 1 is a block diagram schematically illustrating a hardware configuration of a system 1 including a server 10 according to an embodiment of the present invention. As shown in FIG. 1, the server device 10 according to an embodiment may be communicatively connected via a communication network 20 such as the Internet to a terminal device 30 configured as a conventional computer, and may output map images to the terminal device 30. Additionally, the server 10 may be communicatively connected to terminal devices other than the terminal device 30 and not shown. The server 10 may provide various Internet services, and provide a platform service that implements various communications between a plurality of users operating a plurality of terminal devices 30. In these various services provided by the server 10, map images having arranged thereon user elements corresponding to the users may be provided to the terminal devices 30.

As shown, the server 10 may include a central processing unit (CPU) (processor) 11, a main memory 12, a user interface (I/F) 13, a communication I/F 14, an external memory 15, and a disk drive 16, and these components may be electrically connected to one another via a bus 17. The CPU 11 may load an operating system and various programs such as control programs for controlling the provision of various services into the main memory 12 from the external memory 15, and may execute commands included in the loaded programs. The main memory 12 may be used to store a program to be executed by the CPU 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the CPU 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the terminal devices 30 via the communication network 20.

The external memory 15 may be formed of, for example, a magnetic disk drive and store various programs such as a control program for controlling the provision of various services. The external memory 15 may also store various data used in providing the various services. The various data that may be stored in the external memory 15 may also be stored on a database server communicatively connected to the server 10 and physically separate from the server 10. The disk drive 16 may read data stored in a storage medium such as a compact disc read only memory (CD-ROM), digital versatile disc read only memory (DVD-ROM), or DVD Recordable (DVD-R) disc, or write data to such a storage medium.

In an embodiment, the server 10 may be a web server for managing a web site including a plurality of hierarchical web pages. The terminal devices 30 may fetch HTML data for rendering a web page from the server 10 and analyze the HTML data to present the web page to a user of the terminal devices 30. The HTML data for rendering the web page may also be stored on the external memory 15. The HTML data may comprise HTML documents written in markup languages such as HTML; the HTML documents may be associated with various images. Additionally, the HTML documents may include programs written in script languages such as ActionScript™ and JavaScript™.

The external memory 15 may store various applications to be executed on execution environments of the terminal device 30 other than browser software. These various applications may include various programs and various data such as image data to be referred to for executing the programs. The programs may be created in, for example, object oriented languages such as Objective-C™ and Java™. The created programs may be stored on the external memory 15 in the form of application software along with various data. The application software stored on the external memory 15 may be delivered to a terminal device 30 in response to a delivery request. The application software delivered from the server 10 may be received by the terminal device 30 through a communication I/F 34 in accordance with the control of CPU 31 and sent to an external memory 35 for storage thereon. The application software may be launched in accordance with the user's operation on the terminal device 30 and may be executed on a platform implemented on the terminal device 30 such as NgCore™ or Android™. The server 10 may provide the applications executed on the terminal devices 30 with various data required for providing various services. Additionally, the server 10 can store various data sent from the terminal device 30 for each user, thereby managing the provision of the various services.

Thus, the server 10 may manage the web site for providing various services and deliver web pages constituting the web site in response to a request from the terminal device 30, thereby providing various services. Also, the server 10 can provide various services based on communication with an application performed on the terminal device 30 in place of, or in addition to, such browser-based services. Whichever mode may be taken to provide the services, the server 10 can store data required to provide the various services for each identification identifying a user. Briefly, the server 10 may also include a function to authenticate a user at start of provision of services and perform charging process in accordance with provision of services. The types of the various services implemented by the web site or applications of the server 10 are not limited to those explicitly described herein.

In an embodiment, the terminal device 30 may be any information processing device that may display on a web browser a web page of a web site obtained from the server 10 and include an application executing environment for executing applications; and the terminal devices 30 may include smartphones, tablet terminals, and game-dedicated terminals.

As shown, the terminal device 30 may include a central processing unit (CPU) (processor) 31, a main memory 32, a user interface (I/F) 33, a communication I/F 34, an external memory 35, and a GPS receiver 37, and these components may be electrically connected to one another via a bus 36.

The CPU 31 may load various programs such as an operating system into the main memory 32 from the external memory 35, and may execute commands included in the loaded programs. The main memory 32 may be used to store a program to be executed by the CPU 31, and may be formed of, for example, a dynamic random access memory (DRAM).

The user I/F 33 may include an information input device for receiving user inputs and an information output device for outputting an operation result of CPU 31; and the user I/F may include a display device such as a liquid crystal display having a touch panel.

The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server 10 via the communication network 20.

The external memory 35 may comprise, for example, a magnetic disk drive or a flash memory and store various programs such as an operating system. When receiving an application from a server 10 via the communication I/F 34, the external memory 35 may store the received application.

A GPS receiver 37 may be configured as a typical GPS receiver which can receive radio waves from a GPS satellite (not illustrated) which can acquire position information on geographical position of a terminal device 30 (the GPS receiver 37).

A terminal device 30 having such an architecture may include, for example, browser software for interpreting an HTML file (HTML data) and rendering a screen; this browser software may enable the terminal device 30 to interpret the HTML data fetched from the server 10 and render web pages corresponding to the received HTML data. Further, the terminal device 30 may include plug-in software (e.g., Flash Player distributed by Adobe Systems Incorporated) embedded into browser software; therefore, the terminal device 30 can fetch from the server 10 a SWF file embedded in HTML data and execute the SWF file by using the browser software and the plug-in software. Also, the terminal device 30 can execute an application fetched from the server 10.

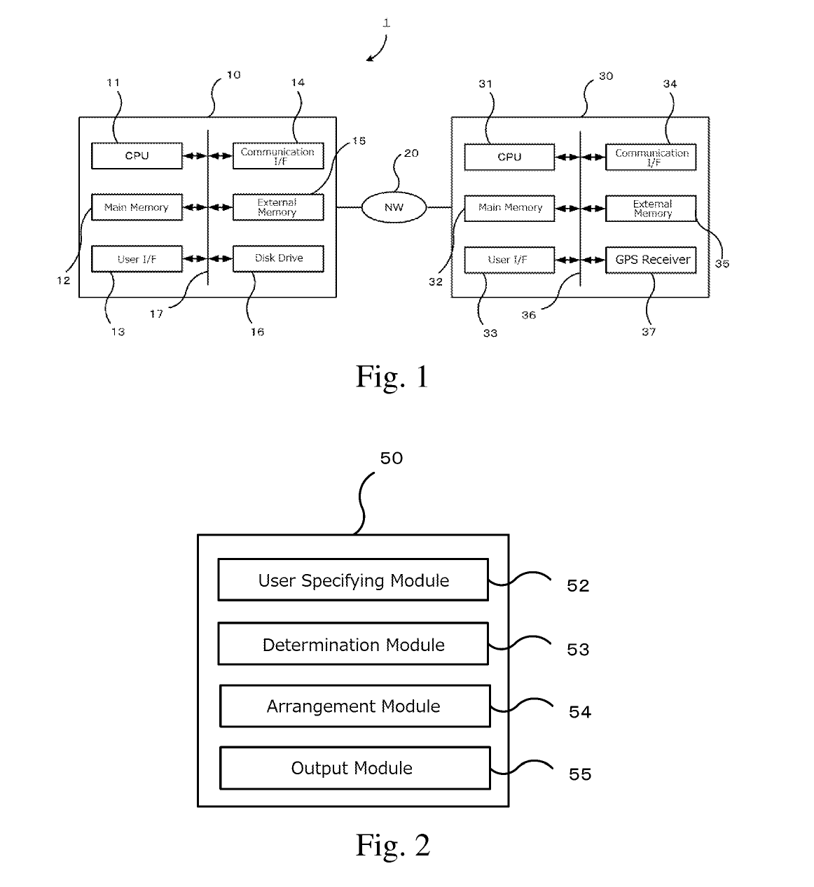

A description will be given below for a map image outputting program 50 executed by a CPU 11 of a server 10 according to one embodiment. FIG. 2 is a block diagram illustrating a module configuration of the map image outputting program 50 according to the one embodiment. The map image outputting program 50 may include, as illustrated in FIG. 2, a user specifying module 52 configured to specify, based at least on the present location of (a geographical position corresponding to) one or more users, the one or more users for whom user elements are arranged on a map image; a determination module 53 configured to determine a modification direction and a modification distance used to modify the present location of the one or more users thus specified; an arrangement module 54 configured to arrange the user elements on the map image at a position corresponding to the present location modified according to the determined modification direction and the determined modification distance; and an output module 55 configured to output to the terminal device 30 the map image having the user elements arranged thereon.

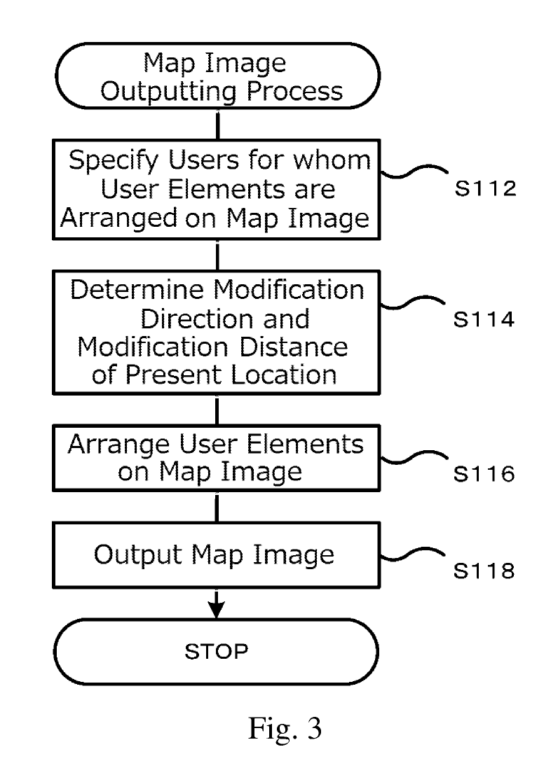

The operation of the server 10 having the above described configuration according to the one embodiment will be described. FIG. 3 is a flowchart illustrating an example of map image outputting processing executed by the server 10. This processing is executed by the server 10 when various types of services using a map image having user elements arranged thereon corresponding to a user are provided for the terminal device 30. More specifically, the processing is executed when a request (including an update request) to output such a map image is made, for example. The request to output such a map image may be made by the terminal device 30, or may be made by other processing of the server 10 (for example, a processing implemented by executing a program other than the map image outputting program 50).

In the map image outputting processing, first, users for whom user elements are arranged on a map image are, as illustrated in FIG. 3, specified based on the present location of the users (step S112). More specifically, a user lying in a geographical area corresponding to the map image of the output request is extracted based on the present location of the users, and these extracted users are specified as the users for whom user elements are arranged on the map image. The present location of the users may be managed, for example, by periodically acquiring from the terminal device 30 a geographical position acquired by the GPS receiver 37 or the like and then storing this acquired geographical position for each user who operates the terminal device 30. The present location of each user thus acquired may be managed by the server 10, or by other server or the like capable of communicating with the server 10. According to the one modification, when users lying in a geographical area corresponding to the map image are extracted, this extraction may be made from users managed as a registered user of the services using the map image. The permission/rejection of arrangement of user elements on a map image (i.e. the permission/rejection of displaying the present location of the user on a map image) may be set for each user; in this case, the user extraction is performed from among users who allow the arrangement of user elements on a map image.

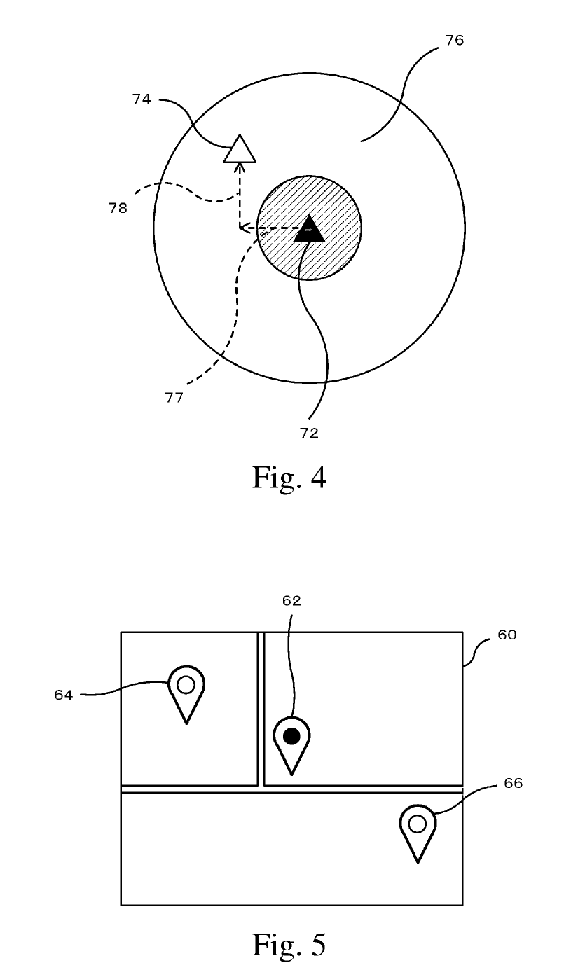

Subsequently, a modification direction and a modification distance for modifying the present location used in arranging user elements on a map image are determined (step S114). The determination of modification direction and modification distance may be made by applying various rules. FIG. 4 is a view for explaining a rule for determining a modification direction and a modification distance according to the one embodiment. According to the one embodiment, a modification direction and a modification distance are, as illustrated in FIG. 4, determined so that the present location after modification (indicated by the void triangle 74 in FIG. 4) falls into the annular area 76 having the present location before modification (the black triangle 72 in FIG. 4) at the center thereof. This annular area 76 is specified as an area of a first circular area of a first radius having the present location before modification at the center thereof, except a second circular area of a second radius smaller than the first radius, having the present location before modification at the center thereof. A modification direction and a modification distance can be determined, for example, by a travel distance in the X-axis direction (indicated by the dotted arrow 77 in FIG. 4) and a travel distance in the Y-axis direction (indicated by the dotted arrow 78 in FIG. 4). A modification direction and a modification distance may be determined by other method; for example, the modification direction itself may be determined by an angle or the like, and the modification distance, by a straight-line distance to the present location after modification. In this way, according to the one embodiment, a modification direction and a modification distance (for example, the travel distance in X-axis direction and the travel distance in Y-axis direction) are determined at random so that the present location of the modification falls into the range of the annular area 76. This random determination of modification direction and modification distance may be made using an arithmetic expression having, as a variable, pseudorandom numbers generated by use of a known algorism.

In this way, the determination of modification direction and modification distance of the present location is made, and subsequently user elements are arranged on a map image at a position corresponding to the present location modified according to the determined modification direction and modification distance (step S116). More specifically, in the one embodiment, the server 10 preliminarily stores the present location after modification of users for whom user elements are arranged on a map image, and then arranges user elements on a map image based on the present location after modification thus stored. Here, another method may be used by which the management of the present location after modification is not performed, and when user elements are arranged on a map image, a required arithmetic processing is performed so that user elements are arranged on a map image at a position corresponding to the present location after modification (for example, the present location after modification is calculated and then a position on a map image corresponding to the present location after modification is calculated.)

After the map image having user elements arranged thereon has been outputted (step S118), this map image outputting processing is terminated. FIG. 5 shows an example of map image 60 having user elements arranged thereon outputted by the server 10 according to the one embodiment. In this example, user icons 62, 64 and 66 as user elements corresponding to the users are, as illustrated in FIG. 5, on a map image 60. The user icon 62 is a user element corresponding to the user who operates the terminal device 30 to which the map image 60 has been outputted; and the user icons 64 and 66 are user elements corresponding to users other than the user who operates the terminal device 30. That is, in the example illustrated in FIG. 5, the present location of the other users lying in the geographical area corresponding to the map image 60 having at the center thereof the present location of the user who operates the terminal device 30, are indicated by the user icons 64 and 66. Here, the user elements arranged on a map image include elements such as texts and the like, other than images such as icons and the like.

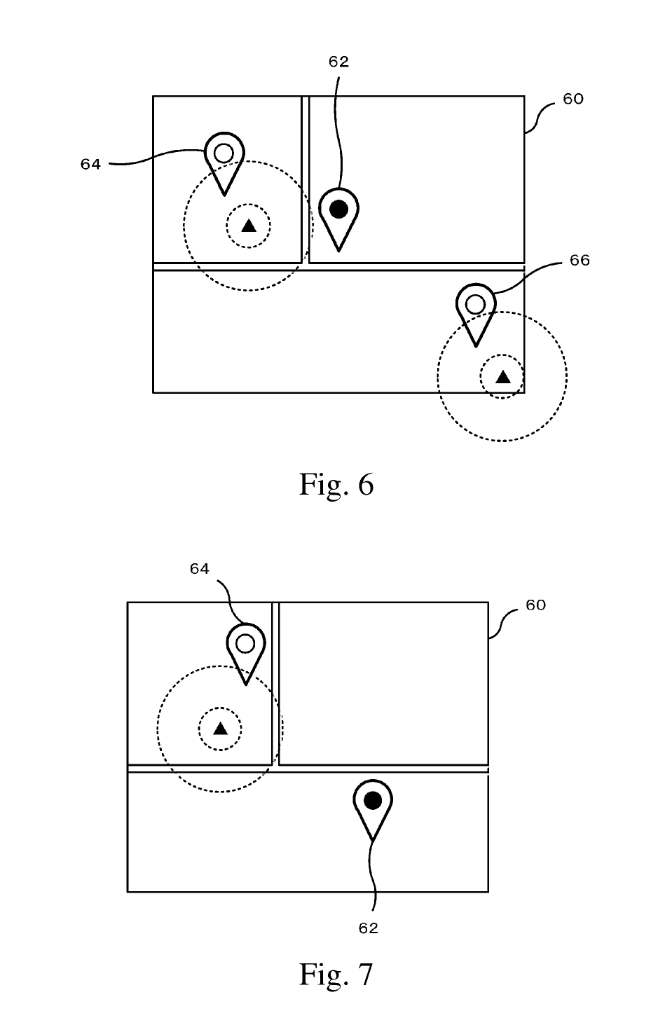

As described above, the position on the map image 60 of the user icon as a user element corresponds to the present location modified according to the determined modification direction and modification distance. FIG. 6 shows the relationship between the position of the user elements and the actual present location of the users on the map image 60. As illustrated in FIG. 6, of the user icons 62, 64 and 66, the user icons 64 and 66 being user elements corresponding to users other than the user who operates the terminal device 30 are arranged on the map image 60, respectively, at a position corresponding to the present location modified in an upper left direction from the present location before modification to a location near the center in a radial direction of the outer circle and of the inner circle, both of which constitute the annular area 76. In one embodiment, the user icon 62 corresponding to the user who operates the terminal device 30 remains at a position on the map image 60 corresponding to the present location before modification. The reason for this is as follows: The user who operates the terminal device 30 to which the map image 60 is outputted knows the actual present location of his/her own, and thus when the position on the map image 60 of the user icon 62 corresponding to this user is modified to a position corresponding to the present location after modification similarly to the user icons 64 and 66 corresponding to the other users, the user who operates the terminal device 30 to which the map image 60 is outputted can easily estimate the present location of the other users, based on the travel direction and the travel distance of the user icon 62 and on the position on the map image 60 of the user icons 64 and 66 corresponding to the other users.

FIG. 7 shows the relationship between the position of user elements and the actual present location of the user on a map image 60 which, after the map image 60 illustrated in FIG. 5 has been outputted to the terminal device 30 by the execution of the map image outputting processing, is outputted to the terminal device 30 as a result of receiving, after the lapse of a given time period, a request to output the map image 60 containing the same geographical area and then executing the map image outputting processing again. In this example, while the actual present location of the user corresponding to the user icon 64 is the same as when the map image 60 illustrated in FIG. 5 is outputted, the modification direction and modification distance determined at step S114 of the map image outputting processing are, as described above, determined at random within the annular area 76 and thus the user icon 64 is arranged on the map image 60 at a position different from when the map image 60 illustrated in FIG. 5 is outputted. In this way, for example, since every time the map image 60 is outputted, the aforementioned modification direction and modification distance are determined at random, when the map image 60 containing the same geographical area is outputted in a repeated manner, the actual present location is difficult to estimate.

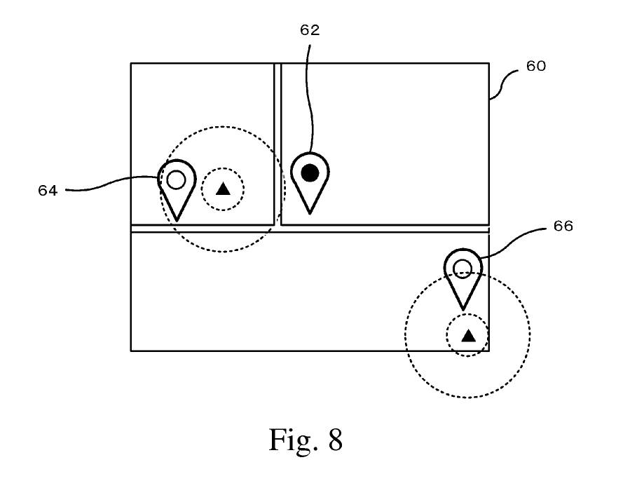

Here, in the map image outputting processing according to the one embodiment, the modification direction and the modification distance determined at step S114 are applied for all the other users; however, the modification direction and the modification distance may be determined for each user. FIG. 8 shows the relationship according to other embodiment between the position of user elements and the actual present location of the users on the map image 60 outputted by the server 10. As illustrated in FIG. 8, in other embodiment, the user icon 64 is arranged on the map image 60 at a position reached as a result of traveling in a lower left direction from the present location before modification to a location near the outer circle; the user icon 66 is arranged on the map image 60 at a position reached as a result of traveling in an upper direction from the present location before modification to a location near the inner circle. In this way, when the modification direction and the modification distance are determined for each user, the actual present location is more difficult to estimate.

Also, in the one embodiment, a method may be used by which the modified present location does not fall into a particular geographical area. More specifically, when user elements are arranged on a map image at a position corresponding to a geographical area such as the sea or a river in which users are usually not supposed to lie, the users may feel something is wrong. Thus, in order to prevent the present location after modification from falling into this particular geographical area, the geographical area such as the sea or a river may be preliminarily stored as the particular geographical area in which user elements are not to be arranged; and when the present location after modification falls into this particular geographical area, the step (step S114) of determining the modification direction and modification distance of the present location may be executed again, or the present location after modification of the user is modified by a given distance so that the present location after modification gets out of the particular geographical area. In this case, the map image outputting program 50 may further include a module corresponding to this processing. Accordingly, when user elements are displayed on a map image based on the present location after modification, it is possible to prevent the user from feeling something is wrong.

In this way, examples of services using map images having user elements arranged thereon corresponding to users include a service which provides various types of communication done between the users. In this case, for example, a user element corresponding to other user with whom communication is to be performed is arranged on a map image, and then this user element arranged on the map image is selected, whereby other user being the other party of the communication can be selected. In this way, when selection among other users is made, the present location of the other users cannot be exactly known, but the present location can be roughly known; this broad information on the present location may be used as a cue for communication.

In the above described server 10 according to one embodiment, a modification direction and a modification distance used to modify the present location of users (the geographical position corresponding to users) are determined according to a request to output a map image, and user elements are arranged on the map image at a position corresponding to the present location modified according to the determined modification direction and the determined modification distance, and the resultant map image is outputted Accordingly, each time a request to output a map image is made, user elements are arranged on a map image at a position corresponding to the present location modified based on a different modification direction and a different modification distance, and thus it is difficult for the user operating the terminal device 30 to which the map image is outputted, to exactly estimate the present location of the other users. That is, the position corresponding to a user can be displayed on the map image with consideration for user privacy.

Further, in the server 10 according to one embodiment, a modification direction and a modification distance of the present location are determined so that the present location after modification falls into the annular area 76 specified as an area of a first circular area of a first radius having the present location before modification at the center thereof, except a second circular area of a second radius smaller than the first radius, having the present location before modification at the center thereof. Consequently, the present location after modification, falling into the first circular area, can be prevented from being significantly far from the present location before modification; further, the present location after modification, lying outside the second circular area, can be prevented from being significantly near the present location before modification. In addition, the modification direction and modification distance are both determined to modify the present location, and thus it is more difficult to exactly estimate the present location of the other users, compared to when only the modification direction is determined and the modification distance is unchanged, and to when only the modification distance is determined and the modification direction is unchanged. Specific value of the first radius and the second radius described above may be set to an appropriate value based on the properties of services or the like using the aforementioned map images.

According to one embodiment, the modification direction and the modification distance of the present location are determined so that the present location after modification falls into the annular area 76. However, the determination may be made so that the present location after modification falls into other area different from the annular area 76. For example, the modification direction and the modification distance may be determined so that the present location after modification falls into the second circular area (containing the first circular area). Further, the shape of area is not limited to a circular ring and a circle; for example, the modification direction and modification distance may be determined so that the present location after modification falls into a rectangular area having a given distance from the present location before modification in the X-axis direction and in the Y-axis direction. Further, various methods of determining the modification direction and the modification distance using various calculating formulas may be applied without specifying the above area.

In one embodiment, each time a request to output a map image is made, the modification direction and the modification distance of the present location are determined in the map image outputting processing; but the modification direction and the modification distance need not necessarily be determined (i.e. modified) each time a request to output a map image is made; for example, in the same session, the modification direction and the modification distance may be determined each time a request to output a map image (i.e. an update request) is made a predetermined number of times.

In one embodiment, the present location of users are illustrated as the geographical position corresponding to the users; but the geographical position is not limited thereto, and various embodiments may be applied in which other geographical positions such as the area of residence, the place of business of each user and the like, is indicated on a map image. In this case, not a geographical position acquired by the GPS receiver 37 or the like, but a geographical position specified by information such as an address manually inputted by users may be modified according to the modification direction and the modification distance, so that user elements may be arranged on a map image at a position corresponding to the geographical position after modification.

The processes and procedures described and illustrated herein may also be implemented by software, hardware, or any combination thereof other than those explicitly stated for the embodiments. More specifically, the processes and procedures described and illustrated herein may be implemented by the installation of the logic corresponding to the processes into a medium such as an integrated circuit, a volatile memory, a non-volatile memory, a magnetic disk, or an optical storage. The processes and procedures described and illustrated herein may also be installed in the form of a computer program, and executed by various computers.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

What is claimed is:

1. A server for outputting to a terminal device communicably connected, a map image having one or more user elements arranged thereon, each corresponding to a respective user, the server comprising one or more processors capable of executing a predetermined program, the predetermined program comprising:
a determination module configured to determine, according to a request to output the map image, a modification direction and a modification distance used to modify a geographical position corresponding to a user having the user element thereof arranged on the map image;
an arrangement module configured to arrange the user elements on the map image at positions corresponding to the geographical positions modified according to the determined modification direction and the determined modification distance; and
an output module configured to output to the terminal device the map image having the user elements arranged thereon.

2. The server according to claim 1,
wherein the determination module determines the modification direction and the modification distance so that the modified geographical position falls into an area predetermined with reference to the geographical position before modification.

3. The server according to claim 2,
wherein the determination module determines the modification direction and the modification distance so that the modified geographical position falls into a first circular area having a first radius and centered at the geographical position before modification.

4. The server according to claim 3,
wherein the determination module determines the modification direction and the modification distance so that the modified geographical position falls into an annular area of the first circular area except a second circular area, the second circular area having a second radius smaller than the first radius and being centered at the geographical position before modification.

5. The server according to claim 1,
wherein the predetermined program includes a user specifying module configured to specify, based at least on one or more geographical positions each corresponding to the respective user, one or more users each having the user element thereof arranged on the map image, and
wherein the determination module determines the modification direction and the modification distance to modify the one or more geographical positions each corresponding to the respective specified user.

6. The server according to claim 5,
wherein the determination module determines the modification direction and the modification distance for each of the one or more users specified.

7. The server according to claim 1,
wherein the arrangement module arranges on the map image at positions corresponding to the geographical positions modified according to the determined modification direction and the determined modification distance, the user elements corresponding to users other than the user operating the terminal device to which the map image is outputted, and arranges on the map image at a position corresponding to the geographical position before modification, the user element corresponding to the user operating the terminal device.

8. A method for outputting a map image having one or more user elements arranged thereon, each corresponding to a respective user, the method comprising:
determining a modification direction and a modification distance used to modify a geographical position corresponding to a user having the user element thereof arranged on the map image, according to a request to output the map image;
arranging the user elements on the map image at a position corresponding to the geographical position modified according to the determined modification direction and the determined modification distance; and
outputting the map image having the user elements arranged thereon.
